(19) United States
(12) Patent Application Publication
(10) Pub. No.: US 2026/0361402 A1
(43) Pub. Date: Nov. 12, 2026

(54) OPTICAL TRANSMISSION DEVICE, MONITORING METHOD, AND MONITORING PROGRAM

(71) Applicant: NTT, Inc., Tokyo (JP)

(72) Inventors: Kana MASUMOTO, Musashino-shi, Tokyo (JP); Takeshi SEKI, Musashino-shi, Tokyo (JP); Takafumi FUKATANI, Musashino-shi, Tokyo (JP)

(21) Appl. No.: 19/129,772

(22) PCT Filed: Dec. 13, 2022
(86) PCT No.: PCT/JP2022/045771

§ 371 Date: May 14, 2025

(51) Int. Cl. H04B 10/077; H04B 10/40; H04J 14/02

(52) U.S. Cl. CPC H04B 10/0775; H04B 10/40; H04J 14/0201

(57) ABSTRACT

A signal quality conversion unit (16) of an optical transmission device (100) includes: a quality measurement unit (161) that measures signal quality of a measurement signal; an ASE light source (163) that transmits a noise signal for the measurement signal so as to be added to a path of the measurement signal; and an SN measurement unit (162) that calculates a ratio between the measurement signal and the noise signal from the received measurement signal and the noise signal, and outputs conversion data indicating a relationship between the signal quality of the measurement signal measured by the quality measurement unit (161) and the ratio between the measurement signal and the noise signal measured by the SN measurement unit (162).

### TECHNICAL FIELD

The present invention relates to an optical transmission device, a monitoring method, and a monitoring program.

### BACKGROUND ART

An optical transmission device constituting an optical transmission system is generally provided by a single vendor, and it has been difficult to interconnect different vendors. However, in recent years, there has been a movement to release vendor lock-in by introducing opening or disaggregation, and to flexibly combine devices. By opening or disaggregation, it is possible to adopt a configuration of cross-vendor connection between optical transmission devices or a configuration of cross-vendor connection between a transponder as a transmission/reception unit and an optical transmission device that accommodates the transponder.

In Non Patent Literature 1, a system of cross-vendor connection between a transponder and an optical transmission device is defined as “Open ROADM MSA”. However, Non Patent Literature 1 does not define a method of monitoring the transponder by the optical transmission device, and it is entrusted to each vendor. A parameter monitored here is, for example, signal quality (bit error rate (BER)).

Patent Literature 1 describes a wavelength tracker as a method of monitoring a transponder. The wavelength tracker identifies the transponder by applying slow amplitude modulation to each optical signal channel.

### CITATION LIST

### Patent Literature

Patent Literature 1: US 6968131 B2

### Non Patent Literature

Non Patent Literature 1: Open ROADM, “Open ROADM MSA Device White Paper for release 7”, [online], [retrieved on Nov. 22, 2022], release 7 v1.2 Nov. 5 , 2020, the Internet <URL:https://0201.nccdn.net/4_2/000/000/072/2aa/open-roadm-msa-release-7-device-white-paper-v1.2.pdf>

### SUMMARY OF INVENTION

### Technical Problem

In the monitoring method of Patent Literature 1, the signal quality of an optical signal flowing in an optical transmission device is measured as a BER. Since the BER cannot be directly measured from the optical signal, it is necessary to measure the BER of an electrical signal after converting the optical signal into the electrical signal.

Therefore, a method of preparing a modulator that performs optical/electrical (O/E) conversion, such as a wavelength tracker of Patent Literature 1, for each channel of the optical signal as a digital signal processor (DSP) is studied. In this system, since the number of modulators increases as the number of monitoring points in the optical transmission device increases, there are concerns about an increase in cost, an increase in power, an increase in failure rate, and the like due to an increase in the number of components. Furthermore, in the cross-vendor connection between the transponder and the optical transmission device, BER information measured by the transponder cannot be managed as it is by a controller of the optical transmission device.

Therefore, a main object of the present invention is to enable monitoring of signal quality of an optical signal flowing in an optical transmission device even in an environment of cross-vendor connection.

### Solution to Problem

To solve the above problem, an optical transmission device of the present invention has the characteristics described below.

The present invention is an optical transmission device including: a common unit that transmits an optical signal flowing through an optical fiber network; and a transponder unit that transmits an optical signal multiplexed/demultiplexed with respect to the optical signal flowing through the common unit, in which the common unit includes a signal quality conversion unit that measures conversion data for converting signal quality of an optical signal, the signal quality conversion unit includes a quality measurement unit that measures signal quality of received measurement signal by transmitting and receiving the measurement signal so as to pass through a transponder of the transponder unit, a noise output unit that transmits a noise signal for the measurement signal so as to be added to a path of the measurement signal, and a ratio measurement unit that calculates a ratio between the measurement signal and the noise signal from the received measurement signal and the noise signal, and the signal quality conversion unit outputs the conversion data indicating a relationship between the signal quality of the measurement signal measured by the quality measurement unit and the ratio between the measurement signal and the noise signal measured by the ratio measurement unit.

### Advantageous Effects of Invention

According to the present invention, it is possible to monitor signal quality of an optical signal flowing in an optical transmission device even in an environment of cross-vendor connection.

### BRIEF DESCRIPTION OF DRAWINGS

FIG. 1 is a configuration diagram of an optical transmission device according to the present embodiment.

FIG. 2 is a configuration diagram of a signal quality conversion unit used in the optical transmission device of FIG. 1 according to the present embodiment.

FIG. 3 is a hardware configuration diagram of the optical transmission device according to the present embodiment.

FIG. 4 is a configuration diagram of the optical transmission device according to the present embodiment.

FIG. 5 is a configuration diagram illustrating a first example of the signal quality conversion unit used in the optical transmission device of FIG. 4 according to the present embodiment.

FIG. 6 is a configuration diagram illustrating a second example of the signal quality conversion unit used in the optical transmission device of FIG. 4 according to the present embodiment.

### DESCRIPTION OF EMBODIMENTS

Hereinafter, one embodiment of the present invention will be described in detail with reference to the drawings.

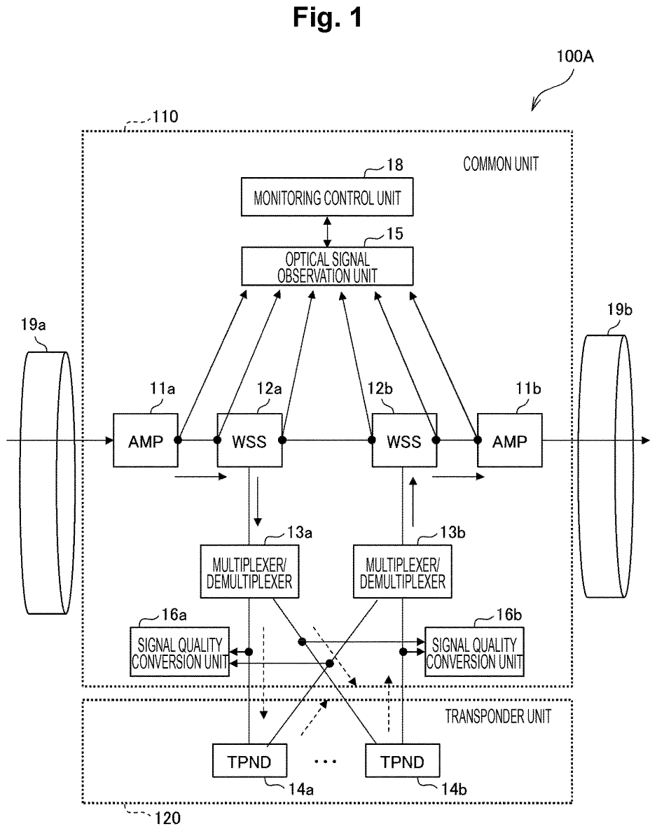

FIG. 1 is a configuration diagram of an optical transmission device 100A.

The optical transmission device 100A is configured by connecting a common unit 110 that transmits an optical signal flowing through an optical fiber network and a transponder unit 120 that transmits an optical signal multiplexed/demultiplexed with respect to the optical signal flowing through the common unit 110. The common unit 110 and the transponder unit 120 may be products of the same vendor or products of different vendors.

The transponder unit 120 accommodates a transponder (TPND) that is a transmission/reception unit of the optical signal. FIG. 1 illustrates an example in which the transponder unit 120 accommodates a plurality of transponders including TPNDs 14a and 14b.

The common unit 110 includes, as a transmission unit of the optical signal, amplifiers (AMPs) 11a and 11b that amplify the optical signal, wavelength selective switches (WSSs) 12a and 12b, and multiplexers/demultiplexers 13a and 13b that multiplex (add) and demultiplex (drop) the optical signal.

For example, in FIG. 1, the optical signal input from an optical fiber 19a passes through the AMP 11a→the WSS 12a→the WSS 12b→the AMP 11b in this order from the left side of the drawing, and is output from an optical fiber 19b. The optical fibers 19a and 19b are, for example, single mode fibers (SMFs).

The multiplexer/demultiplexer 13a further demultiplexes the optical signal demultiplexed from the WSS 12a, and outputs the demultiplexed optical signals to the TPNDs 14a and 14b. The multiplexer/demultiplexer 13b multiplexes the optical signals input from the TPNDs 14a and 14b toward the WSS 12b. Note that, in FIG. 1, the flow of the optical signal after being demultiplexed by the multiplexer/demultiplexer 13a and the flow of the optical signal before being multiplexed by the multiplexer/demultiplexer 13b are indicated by broken line arrows.

Moreover, the common unit 110 includes a monitoring control unit (control unit) 18, an optical signal observation unit 15, and signal quality conversion units 16a and 16b as a mechanism for managing the transmission unit of the optical signal.

The signal quality conversion unit 16a measures conversion data for converting signal quality of the optical signal. For example, the signal quality conversion unit 16a acquires SN/BER as conversion data for calculating (converting) the quality of the optical signal flowing from the multiplexer/demultiplexer 13a to the TPNDs 14a and 14b. The “SN” of the SN/BER is an optical signal-to-noise ratio (SN), and the “BER” is the above-described signal quality. The SN/BER is not limited to the ratio between the SN and the BER, but is data indicating a relationship between the SN and the BER, and is used as conversion data for converting the signal quality of the optical signal (converting the SN into the BER).

The signal quality conversion unit 16b acquires the SN/BER in the optical signal flowing from the TPNDs 14a and 14b to the multiplexer/demultiplexer 13b.

In FIG. 1, N signal quality conversion units 16a, 16b, . . . are prepared for N TPNDs 14a, 14b, . . . so that the signal quality conversion unit 16a and the TPND 14a correspond on a one-on-one basis.

When communication of the optical signal flowing through the common unit 110 is started, the optical signal observation unit 15 observes an SN (a ratio between a data signal and a noise signal) of the optical signal from a monitoring point of each section of the transmission unit (the AMP 11a→the WSS 12a→the WSS 12b→the AMP 11b) of the optical signal.

The monitoring control unit 18 monitors (monitoring) and controls (controlling) the transmission unit of the optical signal. The monitoring control unit 18 calculates the signal quality (BER) of the optical signal from the SN of the optical signal in each section observed by the optical signal observation unit 15, using the conversion data (SN/BER) obtained by the signal quality conversion units 16a and 16b. As a result, the monitoring control unit 18 monitors the signal quality of each section without performing O/E conversion of the optical signal into the electrical signal.

Note that, in FIG. 1, a conversion section (for example, between the multiplexer/demultiplexer 13a and the TPNDs 14a and 14b) of the signal quality conversion unit 16a and an observation section (for example, between the AMP 11a→the WSS 12a) of the optical signal observation unit 15 have been described as different sections. Meanwhile, even in the same device, the SN/BER may be different for each section in the device. Therefore, the conversion section of the signal quality conversion unit 16a may be appropriately applied to the observation section of the optical signal observation unit 15 such that the conversion section of the signal quality conversion unit 16a and the observation section of the optical signal observation unit 15 become the same section.

As a result, the monitoring control unit 18 can calculate the BER of the optical signal with high accuracy by applying the SN/BER obtained in the conversion section (for example, between the AMP 11a→the WSS 12a) of the signal quality conversion unit 16a to the SN of the optical signal observed in the observation section (for example, between the AMP 11a→the WSS 12a) of the optical signal observation unit 15.

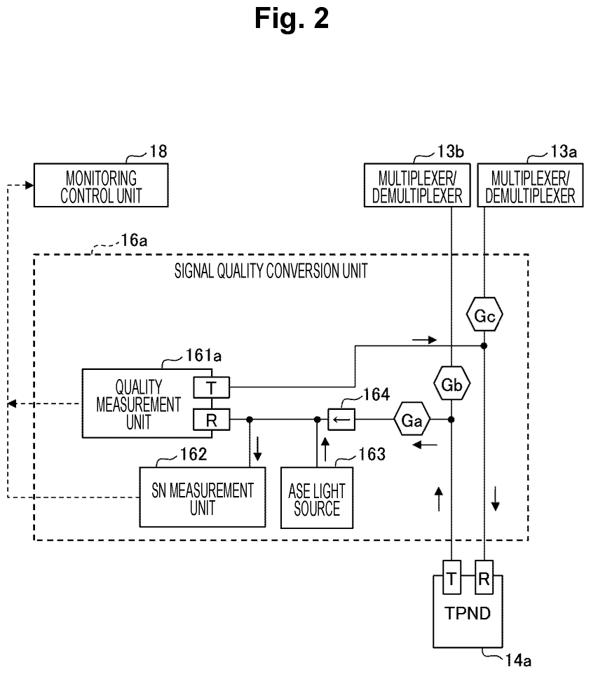

FIG. 2 is a configuration diagram of the signal quality conversion unit 16a used in the optical transmission device 100A of FIG. 1.

The signal quality conversion unit 16a includes a quality measurement unit 161a, an SN measurement unit (ratio measurement unit) 162, an amplified spontaneous emission (ASE) light source (noise output unit) 163, a cutoff circuit 164, and gates Ga, Gb, and Gc.

The gates Ga, Gb, and Gc are switched between ON and OFF in a measurement mode in which measurement is performed and a normal mode in which measurement is not performed (details will be described in a procedure to be described below).

The quality measurement unit 161a measures the signal quality (BER) of a received measurement signal by transmitting and receiving the measurement signal so as to pass through the TPND 14 of the transponder unit 120 in the measurement mode. The measurement signal is an optical signal (S signal) to be S (Signal) of the SN measured by the SN measurement unit 162.

Note that, in a case where the optical signal is used as the measurement signal, the quality measurement unit 161a can measure the signal quality (BER) of the converted electrical signal by performing O/E conversion for the received measurement signal. In addition, since the quality measurement unit 161a is connected to the TPND 14a of various specifications, it is desirable to be able to support various specifications (settings such as a modulation method).

The quality measurement unit 161a includes a T terminal on a transmission side (T terminal is only for transmission) and an R terminal on a reception side (R terminal is only for reception), and has a function of a transponder.

The quality measurement unit 161a outputs the S signal from the T terminal, and receives the S signal at the R terminal of the TPND 14a to be measured.

The quality measurement unit 161a receives the S signal output from the T terminal of the TPND 14a and an N signal (details will be described below) output from the ASE light source 163 at the R terminal, and evaluates the BER of the TPND 14a from received content. In general, the measurement is performed such that the BER of the S signal decreases due to an interference as power of the N signal increases. The quality measurement unit 161a outputs the evaluated BER to the monitoring control unit 18.

The ASE light source 163 is a light source that amplifies and emits spontaneous emission light (ASE light). That is, the ASE light source 163 transmits ASE light to be added to a path of the measurement signal as a noise signal for the measurement signal. The noise signal is a signal (N signal) to be N (noise) of the SN measured by the SN measurement unit 162.

Note that the ASE light source 163 increases power of the N signal by increasing intensity of the ASE light. Even if the power of the S signal is constant, it is possible to deteriorate the signal quality of the S signal in a pseudo manner as the power of the N signal increases.

The cutoff circuit 164 cuts off only an optical signal in a predetermined direction among the optical signals passing through connected lines. For example, since the arrow “←” is described, the cutoff circuit 164 of FIG. 2 allows a signal flowing from the left to the right in the drawing to pass therethrough and cuts off a signal flowing from the right to the left in the opposite direction.

The SN measurement unit 162 is a measuring instrument such as a spectrum analyzer, measures the SN (the ratio between the measurement signal and the noise signal) in a connected section (a section from the R terminal of the quality measurement unit 161a to the cutoff circuit 164), and outputs a result to the monitoring control unit 18. Therefore, the S signal output from the quality measurement unit 161a and the N signal output from the ASE light source 163 are input to the SN measurement unit 162.

The monitoring control unit 18 receives the BER received from the quality measurement unit 161a and the SN received from the SN measurement unit 162, and calculates the conversion data (SN/BER) indicating the relationship between the two.

Hereinafter, (procedure 1) to (procedure 6) will be specifically described with respect to the processing of the signal quality conversion unit 16a of FIG. 2.

(Procedure 1) When it is confirmed that the TPND 14a has been inserted, the monitoring control unit 18 shifts from the normal mode to the measurement mode. In the measurement mode, the monitoring control unit 18 sets “the gate Ga=ON (signal passing), the gate Gb=OFF (signal cutoff), and the gate Gc=OFF”. As a result, the S signal flows through the T terminal of the TPND 14a→the quality measurement unit 161a→the R terminal of the TPND 14a, and communication of the TPND 14a with units other than with the quality measurement unit 161a is cut off.

(Procedure 2) In the measurement mode, the TPND 14a outputs the S signal, and the ASE light source 163 outputs the N signal at certain constant power. In this state, the quality measurement unit 161a measures the BER, and the SN measurement unit 162 measures the SN.

(Procedure 3) The monitoring control unit 18 receives the BER from the quality measurement unit 161a and the SN from the SN measurement unit 162, which have been respectively measured from the same signal (signal flowing in the same period) in (procedure 2), as measurement results.

(Procedure 4) The ASE light source 163 gradually increases the N signal of (procedure 2). At each increase, (procedure 2) and (procedure 3) are executed.

(Procedure 5) (procedure 4) is executed until the BER output from the quality measurement unit 161a falls below a BER limit. The BER limit is a limit characteristic capable of demodulating the S signal into the optical signal.

(Procedure 6) When it is confirmed that the BER output from the quality measurement unit 161a falls below the BER limit, the monitoring control unit 18 returns the mode from the measurement mode to the normal mode. In the normal mode, the quality measurement unit 161a stops the output of the S signal and the ASE light source 163 also stops the output of the N signal, and “the gate Ga=OFF, the gate Gb=ON, and the gate Gc=ON” is set. This enables the communication between the TPND 14a and the multiplexer/demultiplexer 13a, so that the TPND 14a can communicate via the optical transmission device 100.

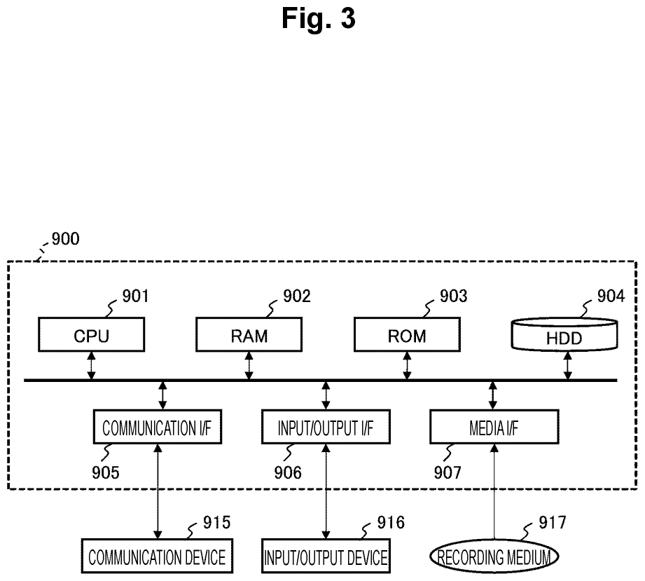

FIG. 3 is a hardware configuration diagram of the optical transmission device 100A.

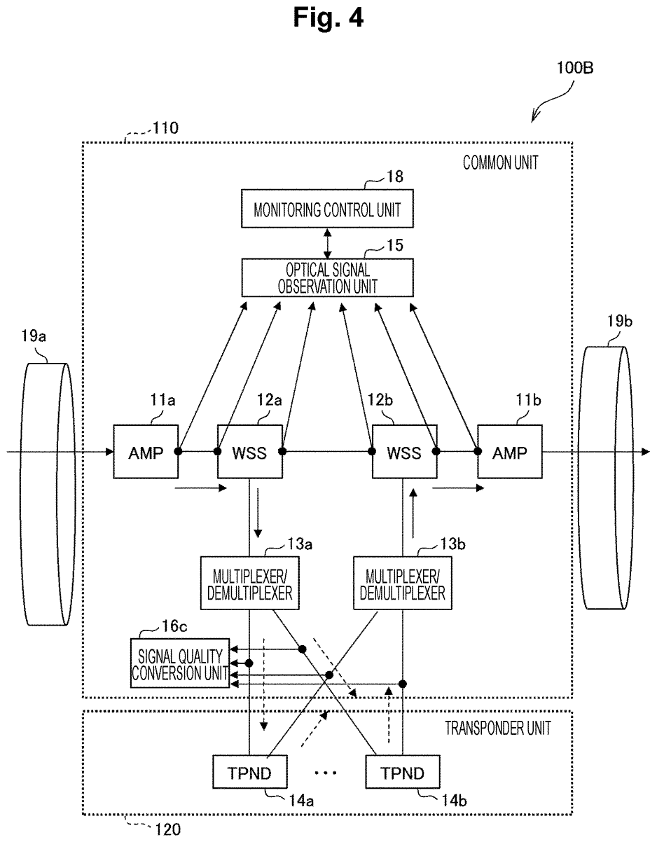

The optical transmission device 100A and an optical transmission device 100B to be described below with reference to FIG. 4 are configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. Moreover, the CPU 901 controls each unit by executing a program (also referred to as an application or an app for abbreviation thereof) read into the RAM 902. Then, the program may be distributed via a communication line or distributed by being recorded in the recording medium 917 such as a CD-ROM.

FIG. 4 is a configuration diagram of the optical transmission device 100B.

As compared with the optical transmission device 100A of FIG. 1, the optical transmission device 100B of FIG. 4 is changed such that one signal quality conversion unit 16c measures a plurality of measurement targets (TPNDs 14a and 14b). Note that the optical transmission device 100A in FIG. 1 is configured such that one signal quality conversion unit 16a measures one TPND 14a.

As described above with reference to FIG. 4, the signal quality conversion unit 16 may be configured to individually output the conversion data for each of the plurality of TPNDs 14.

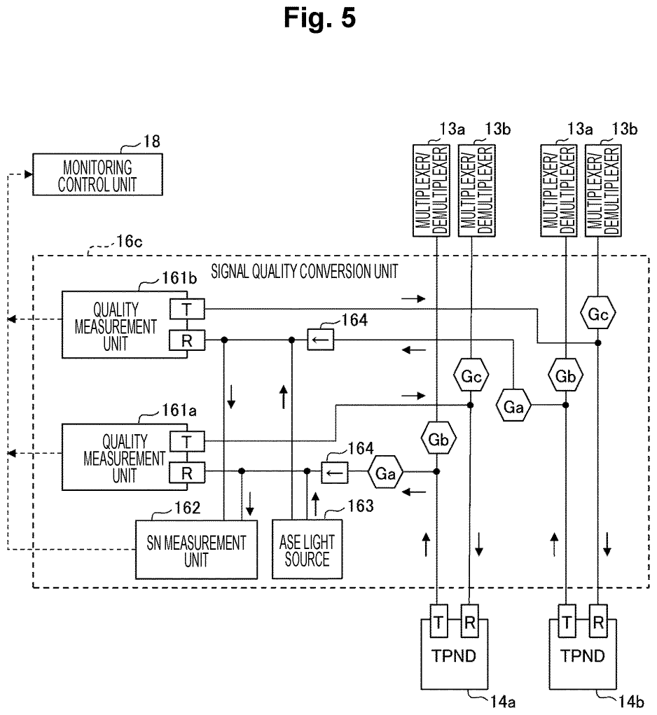

FIG. 5 is a configuration diagram illustrating a first example of the signal quality conversion unit 16c used in the optical transmission device 100B of FIG. 4.

As compared with the signal quality conversion unit 16a of FIG. 2, the number of measurement targets is increased to two in the signal quality conversion unit 16c of FIG. 5, and thus, quality measurement units 161a and 161b for the respective measurement targets are prepared.
The first quality measurement unit 161a measures the TPND 14a as a first measurement target. A first gate set (gates Ga, Gb, and Gc) and a first cutoff circuit 164 are also prepared along the path of the optical signal output from the first quality measurement unit 161a.
The second quality measurement unit 161b measures the TPND 14b as a second measurement target. A second gate set (gates Ga, Gb, and Gc) and a second cutoff circuit 164 are also prepared along the path of the optical signal output from the second quality measurement unit 161b.

As described above with reference to FIG. 5, one quality measurement unit (such as the quality measurement unit 161a) is provided for each measurement target (such as the TPND 14a). That is, the signal quality conversion unit 16 includes, for each TPND 14, the quality measurement unit 161 configured such that the path of the measurement signal caused to pass through each TPND 14 does not overlap the path of the measurement signal caused to pass through another TPND 14.

Meanwhile, since the SN measurement unit 162 and the ASE light source 163 can be shared by the plurality of measurement targets, the number of components of the optical transmission device 100 can be reduced.

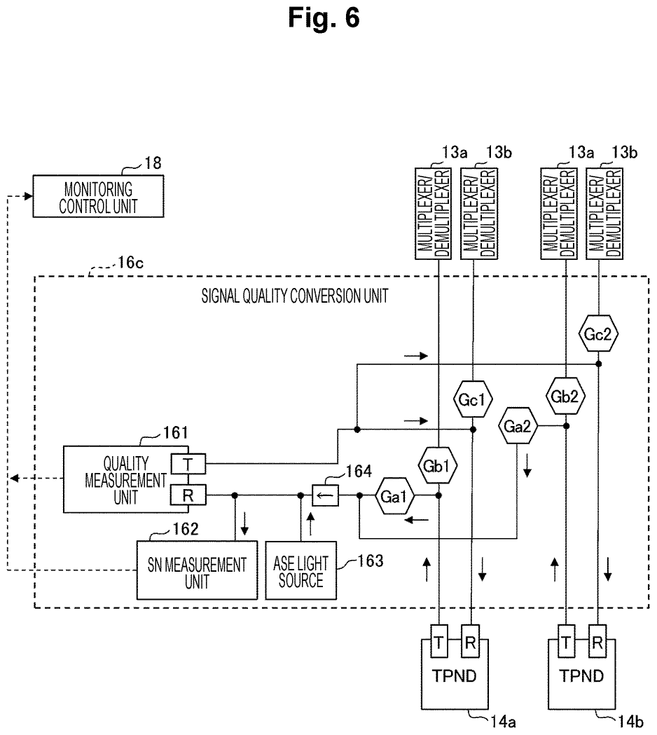

FIG. 6 is a configuration diagram illustrating a second example of the signal quality conversion unit 16c used in the optical transmission device 100B of FIG. 4.

In both of FIG. 5 and FIG. 6, the two measurement targets, the TPND 14a and the TPND 14b, are measured. Meanwhile, in the signal quality conversion unit 16c of FIG. 5, the two quality measurement units 161a and 161b are prepared for two measurement targets, whereas in the signal quality conversion unit 16c of FIG. 6, one quality measurement unit 161 is prepared for the two measurement targets, and the quality measurement unit 161 is replaced with a configuration of measuring each measurement target with a time difference.

As a result, although a measurement time increases, the number of components (the number of DSPs) of the optical transmission device 100B can be reduced.

Hereinafter, (procedure 1) to (procedure 8) of an i-th measurement mode for measuring an i-th measurement target (i=1, 2, . . . , n) will be specifically described with respect to the processing of the signal quality conversion unit 16c of FIG. 6.

(Procedure 1) When it is confirmed that the TPNDS 14a and 14b of all the measurement targets have been inserted, the monitoring control unit 18 starts the following processing from i=1. Further, i≠j.

(Procedure 2) As preparation for the i-th measurement mode, the monitoring control unit 18 sets “the gate Gai=ON, the gate Gbi=OFF, and the gate Gci=OFF” of the i-th measurement target and sets “the gate Gaj=OFF, the gate Gbj=OFF, and the gate Gcj=OFF” of the j-th measurement target. For example, in a case of i=1, the followings are set:
the gate Ga1=ON, the gate Gb1=OFF, and the gate Gc1=OFF; and
the gate Ga2=OFF, the gate Gb2=OFF, and the gate Gc2=OFF.

As a result, the S signal output from the T terminal of the transponder serving as the i-th measurement target is input from the R terminal of the quality measurement unit 161, and a normal optical signal (an optical signal other than the S signal) in the i-th measurement target is cut off. Meanwhile, the S signal does not flow out to the j-th measurement target, and the normal optical signal is also cut off.

(Procedure 3) The quality measurement unit 161 outputs the S signal as the i-th measurement mode, and the ASE light source 163 outputs the N signal at certain constant power. In this state, the quality measurement unit 161 measures the BER, and the SN measurement unit 162 measures the SN.

(Procedure 4) The monitoring control unit 18 receives the BER from the quality measurement unit 161 and the SN from the SN measurement unit 162, which have been respectively measured from the same signal (signal flowing in the same period) in (Procedure 3), as measurement results of the i-th measurement target.

(Procedure 5) The ASE light source 163 gradually increases the N signal of (procedure 3). At each increase, (procedure 4) and (procedure 5) are executed.

(Procedure 6) (procedure 5) is executed until the BER output from the quality measurement unit 161 falls below the BER limit.

(Procedure 7) When the monitoring control unit 18 confirms that the BER output from the quality measurement unit 161 falls below the BER limit, the quality measurement unit 161 stops the output of the S signal and terminates the i-th measurement mode. Here, 1 is added to i (i=i+1), and thereafter, if i>the number of measurement targets n, the processing proceeds to (procedure 8), and if i≤the number of measurement targets n, the processing returns to (procedure 2).

(Procedure 8) The monitoring control unit 18 returns the mode from the i-th measurement mode to the normal mode. In the normal mode, the quality measurement unit 161 stops the output of the S signal, and the ASE light source 163 also stops the output of the N signal. Further, the monitoring control unit 18 sets “the gate Gak=OFF, the gate Gbk=ON, and the gate Gck=ON” (k=1, 2, . . . , n). This enables the communication with the normal optical signal in each measurement target.

As described in FIG. 6 above, the signal quality conversion unit 16 includes one quality measurement unit 161 configured such that the path of the measurement signal caused to pass through each TPND 14 partially overlaps the path of the measurement signal caused to pass through another TPND 14.

Then, the signal quality conversion unit 16 outputs the conversion data for the predetermined TPND 14 by cutting off the path to another TPND 14 in a time zone in which the measurement signal is caused to pass through the predetermined TPND 14.

### Effects

The optical transmission device 100A or 100B of the present invention is the optical transmission device 100 including: the common unit 110 that transmits the optical signal flowing through an optical fiber network; and the transponder unit 120 that transmits the optical signal multiplexed/demultiplexed with respect to the optical signal flowing through the common unit 110, in which
the common unit 110 includes the signal quality conversion unit 16 that measures the conversion data for converting the signal quality of the optical signal,
the signal quality conversion unit 16 includes
   the quality measurement unit 161 that measures the signal quality of the received measurement signal by transmitting and receiving the measurement signal so as to pass through the TPND 14 of the transponder unit 120,
   the ASE light source 163 that transmits the noise signal for the measurement signal so as to be added to the path of the measurement signal, and
   the SN measurement unit 162 that calculates the ratio between the measurement signal and the noise signal from the received measurement signal and the noise signal, and
the signal quality conversion unit 16 outputs the conversion data indicating the relationship between the signal quality of the measurement signal measured by the quality measurement unit 161 and the ratio between the measurement signal and the noise signal measured by the SN measurement unit 162.

As a result, the optical transmission device 100A or 100B can acquire a parameter that is the conversion data not depending on a vendor specification, and thus can monitor the signal quality of the optical signal flowing in the optical transmission device even in an environment of cross-vendor connection.

In the optical transmission device 100A or 100B of the present invention, the optical transmission device 100 further includes: the optical signal observation unit 15; and the monitoring control unit 18, in which
the optical signal observation unit 15 observes, for the optical signal flowing through the common unit 110, the ratio between the data signal and the noise signal, and
the monitoring control unit 18 converts the ratio between the data signal and the noise signal observed by the optical signal observation unit 15 into the signal quality of the optical signal flowing through the common unit 110 according to the conversion data output from the signal quality conversion unit 16.

As a result, the optical transmission device 100A or 100B can monitor the signal quality (BER) without performing the O/E conversion for the optical signal with respect to the observation point of the common unit 110.

In the optical transmission device 100B of the present invention, the signal quality conversion unit 16 individually outputs the conversion data for each of the plurality of TPNDs 14.

As a result, the optical transmission device 100B can reduce the number of electrical components by causing one signal quality conversion unit 16 to process the plurality of measurement targets.

In the optical transmission device 100B of the present invention, the signal quality conversion unit 16 includes, for each TPND 14, the quality measurement unit 161 configured such that the path of the measurement signal caused to pass through each TPND 14 does not overlap the path of the measurement signal caused to pass through another TPND 14.

As a result, the optical transmission device 100B can simultaneously measure the plurality of measurement targets, and thus can shorten the measurement time.

In the optical transmission device 100B of the present invention, the signal quality conversion unit 16 includes one quality measurement unit 161 configured such that the path of the measurement signal caused to pass through each TPND 14 partially overlaps the path of the measurement signal caused to pass through another TPND 14, and
the signal quality conversion unit 16 outputs the conversion data of the predetermined TPND 14 by cutting off the path to the other TPND 14 in the time zone in which the measurement signal is caused to pass through the predetermined TPND 14.

As a result, the optical transmission device 100B can reduce the number of electrical components by causing the path of the measurement signal to be partially shared among the plurality of measurement targets.

### REFERENCE SIGNS LIST

11a, 11b AMP
12a, 12b WSS
13a, 13b Multiplexer/demultiplexer
14a, 14b Transponder (TPND)
15 Optical signal observation unit
16a, 16b, 16c Signal quality conversion unit
18 Monitoring control unit (control unit)
19a, 19b Optical fiber
100A, 100B Optical transmission device
110 Common unit
120 Transponder unit
161, 161a, 161b Quality measurement unit
162 SN measurement unit (ratio measurement unit)
163 ASE light source (noise output unit)
164 Cutoff circuit

1. An optical transmission device comprising:
a common unit, including one or more processors, configured to transmit an optical signal flowing through an optical fiber network; and
a transponder unit, including one or more processors, configured to transmit an optical signal multiplexed/demultiplexed with respect to the optical signal flowing through the common unit, wherein
the common unit includes a signal quality conversion unit configured to measure conversion data for converting signal quality of an optical signal,
the signal quality conversion unit includes
a quality measurement unit configured to measure signal quality of received measurement signal by transmitting and receiving the measurement signal so as to pass through a transponder of the transponder unit,
a noise output unit configured to transmit a noise signal for the measurement signal so as to be added to a path of the measurement signal, and
a ratio measurement unit configured to calculate a ratio between the measurement signal and the noise signal from the received measurement signal and the noise signal, and
the signal quality conversion unit is configured to output the conversion data indicating a relationship between the signal quality of the measurement signal measured by the quality measurement unit and the ratio between the measurement signal and the noise signal measured by the ratio measurement unit.

2. The optical transmission device according to claim 1, further comprising:
an optical signal observation unit including one or more processors; and
a control unit including one or more processors, wherein
the optical signal observation unit is configured to observe, for the optical signal flowing through the common unit, a ratio between a data signal and the noise signal, and
the control unit is configured to convert the ratio between a data signal and the noise signal observed by the optical signal observation unit into the signal quality of the optical signal flowing through the common unit according to the conversion data output from the signal quality conversion unit.

3. The optical transmission device according to claim 1, wherein the signal quality conversion unit is configured to individually output the conversion data for each of a plurality of the transponders.

4. The optical transmission device according to claim 3, wherein the signal quality conversion unit includes, for each of the transponders, the quality measurement unit configured such that a path of the measurement signal caused to pass through each of the transponders does not overlap a path of the measurement signal caused to pass through another one of the transponders.

5. The optical transmission device according to claim 3, wherein
the signal quality conversion unit includes one of the quality measurement units configured such that a path of the measurement signal caused to pass through each of the transponders partially overlaps a path of the measurement signal caused to pass through another one of the transponders, and
the signal quality conversion unit is configured to output the conversion data of the predetermined transponder by cutting off the path to the other one of the transponders in a time zone in which the measurement signal is caused to pass through the predetermined transponder.

6. A monitoring method by an optical transmission device including a common unit configured to transmit an optical signal flowing through an optical fiber network, and a transponder unit configured to transmit an optical signal multiplexed/demultiplexed with respect to the optical signal flowing through the common unit, wherein
the common unit includes a signal quality conversion unit that measures conversion data for converting signal quality of an optical signal, and
the signal quality conversion unit is configured to
measure signal quality of a received measurement signal by transmitting and receiving the measurement signal so as to pass through a transponder of the transponder unit,
transmit a noise signal for the measurement signal so as to be added to a path of the measurement signal,
calculate a ratio between the measurement signal and the noise signal from the received measurement signal and the noise signal, and
output the conversion data indicating a relationship between the measured signal quality of the measurement signal and the measured ratio between the measurement signal and the noise signal.

7. A non-transitory computer-readable storage medium monitoring program for causing a computer to function as an optical transmission device comprising a common unit configured to transmit an optical signal flowing through an optical fiber network, and a transponder unit configured to transmit an optical signal multiplexed/demultiplexed with respect to the optical signal flowing through the common unit, wherein
the common unit includes a signal quality conversion unit that measures conversion data for converting signal quality of an optical signal, and
the signal quality conversion unit is configured to
measure signal quality of a received measurement signal by transmitting and receiving the measurement signal so as to pass through a transponder of the transponder unit.
transmit a noise signal for the measurement signal so as to be added to a path of the measurement signal,
calculate a ratio between the measurement signal and the noise signal from the received measurement signal and the noise signal, and
output the conversion data indicating a relationship between the measured signal quality of the measurement signal and the measured ratio between the measurement signal and the noise signal.
